(19) United States
(12) Patent Application Publication
(10) Pub. No.: US 2008/0209030 A1
(43) Pub. Date: Aug. 28, 2008

(54) Mining Web Logs to Debug Wide-Area Connectivity Problems

(75) Inventors: Moises Goldszmidt, Palo Alto, CA (US); Emre M. Kiciman, Seattle, WA (US); David A. Maltz, Bellevue, WA (US); John C. Platt, Redmond, WA (US)

Correspondence Address: Steven C. Stewart;Lee & Hayes, PLLC, Suite 500, 421 W. Riverside Avenue, Spokane, WA, 99201, US

(73) Assignee: MICROSOFT CORPORATION, Redmond, WA (US)

(21) Appl. No.: 11/680,483

(22) Filed: Feb. 28, 2007

(51) Int. Cl. G06F 15/173

(52) U.S. Cl. 709/224

(57) ABSTRACT

Internet service providers and their clients communicate by transmitting messages across one or more networks and infrastructure components. At various points between the service provider and the clients, inclusively, records may be created of each messages occurrence and status. These records may be read and analyzed to determine the effects of the networks and infrastructure components on the provided quality of service. User-effecting incidents (e.g., failures) occurring at networks may also be identified and described.

### BACKGROUND

Internet service providers, such as search engines, webmail, news and other web sites, typically provide content from a content server of a service provider to a user over the Internet, a wide-area network comprised of many cooperating networks, joined together to transport content. The components involved in the process of providing content from a service provider to a user may include electronic devices such as central servers, proxy servers, content distribution network (CDN) nodes, and the user's web browsers being displayed on a client device. To transfer content, a request may be initiated by the end-user, originating within one network to a server operated by the service provider, possibly in another network, and the server responds by providing the requested content. In order for a request to succeed, every component involved in the requests initiation, transport, and service must operate correctly. Any one of these components may fail due to hardware problems, physical connectivity disruptions, software bugs or human error and thus disrupt the flow of information between the service provider and the user.

Service providers' businesses depend on the service providers' ability to reliably receive and answer requests from client devices distributed across the Internet. Since disruptions in the flow of these requests directly translate into lost revenue for the service providers, there is a tremendous incentive to diagnose the cause of failed requests and to prod the responsible parties into corrective action. However, the service provider may have only limited visibility into the state of the Internet outside its own domain, such as with the networks over which neither the client nor the server have any control. Thus the service provider may not be able to diagnose the entity responsible for the failure.

### SUMMARY

A service provider can monitor web logs (records of HTTP request successes or failures and related information between a service provider and its client computers) stored on a server to diagnose and resolve reliability problems in a wide-area network, including problems with the networks and components thereof that are affecting end-user perceived reliability. The web log may be analyzed to determine quality and debug end-to-end reliability of an Internet service across a wide-area network, and an application of statistical algorithms may be used for identifying when user-affecting incidents (e.g., failures) within the wide-area Internet infrastructure have begun and ended. As part of the analysis, specific networks and components with the user-affecting incidents may be identified and located, and properties of the incidents (e.g., the number of clients effected) may be inferred.

In another embodiment, a computer may infer an impact of one or more of the infrastructure component(s) on the service quality experienced by the clients of the service provider based on an analysis of records of messages sent between the clients and the service provider. The records of messages may either explicitly or implicitly represent the effect of plurality of infrastructure components on the message's achieved quality of service. Further, some of the infrastructure components may be external to an administrative domain of the service provider.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 illustrates simplified diagram of a workflow for analyzing web logs to debug wide-area network failures.

FIG. 2 illustrates an example system in which web log mining may be implemented to debug distant connectivity problems. The architecture includes clients connected via several cooperating networks.

FIG. 3 illustrates a flow diagram of an exemplary process for mining web logs to debug distant connectivity problems over the architecture shown in FIG. 2.

FIG. 4 illustrates a flow diagram of an exemplary process for analyzing logs to determine failures.

FIGS. 5a and 5b illustrates graphical representation of an exemplary observed system-wide failure rate during a 3-hour period. FIG. 5a illustrates the overall system failure rate. FIG. 5b illustrates the failure rates of Autonomous Systems that contributed to the overall system-wide failure rate show in FIG. 5a.

### DETAILED DESCRIPTION

Service providers derive value from offering services to clients, and the offering of these services generally requires one or more messages be sent between a client and a service provider or a service provider and a client. In the case of a web service, the client of one service provider may actually be a service provider to another client. The movement of these messages involves networks and other elements of infrastructure, collectively referred to as components. Logs or records relevant to an exchange of messages between a client and a service provider may be available from any of the components involved in processing a message or any of the ancillary or prerequisite components used by those components. Any component creating such logs provides a potential vantage point on the exchange of messages.

This disclosure is directed to techniques for mining the logs available from vantage points to determine the effect of the components on the service quality a client sees when accessing the service provider. Service quality may include aspects of availability, latency, and the success or failure of requests. The effects revealed by the disclosed embodiment comprise: (1) identifying components responsible for decreasing or increasing the service quality; (2) estimating the magnitude of the effect on service quality due to a component; (3) estimating the impact of the components, which means identifying the number of clients or components affected by a component.

In one embodiment, the disclosed embodiment may be used to debug connectivity problems in a wide-area network comprised of many third-party cooperating networks, such as the Internet. In this embodiment the logs processed by the invention will be web logs, but it will be appreciate by one skilled in the art that this invention is applicable to analysis of any type of log where the log provides information about the effect of one or more components on the service quality experienced by one or more messages traveling to or from a service provider. Generally, one or more web logs are created when various users or clients submit Hyper Text Transfer Protocol (HTTP) requests, originating within one network access a server belonging to a service provider residing in the same or different network. A service provider operates computers for the purpose of making a service available over a computer network to clients or client computers. For example, a company operating a web site, such as CNN.com, is a service provider where the provided service is web content provided using the HTTP protocol and streaming video.

In the case where clients submit a request to a service provider residing in a different network; the request may be transported via a series of cooperating third-party networks. As described above, web logs may be created at one or more vantage points as the request travels to the service provider and a response is returned. These web logs are read from time to time. Based on an analysis of the aggregate web logs, failure rates of third-party networks and their infrastructure components may be determined. This analysis may include data mining, statistical analysis and modeling. In one embodiment, stochastic gradient descent (SGD) is used to determine such probabilities. When the failure rate of one of the networks exceeds a predetermined threshold value or increases abruptly, an indication is logged or an alarm is raised. In another embodiment, abrupt changes in the failure rate are detected to determine the occurrence of one or more failure incidents of the components.

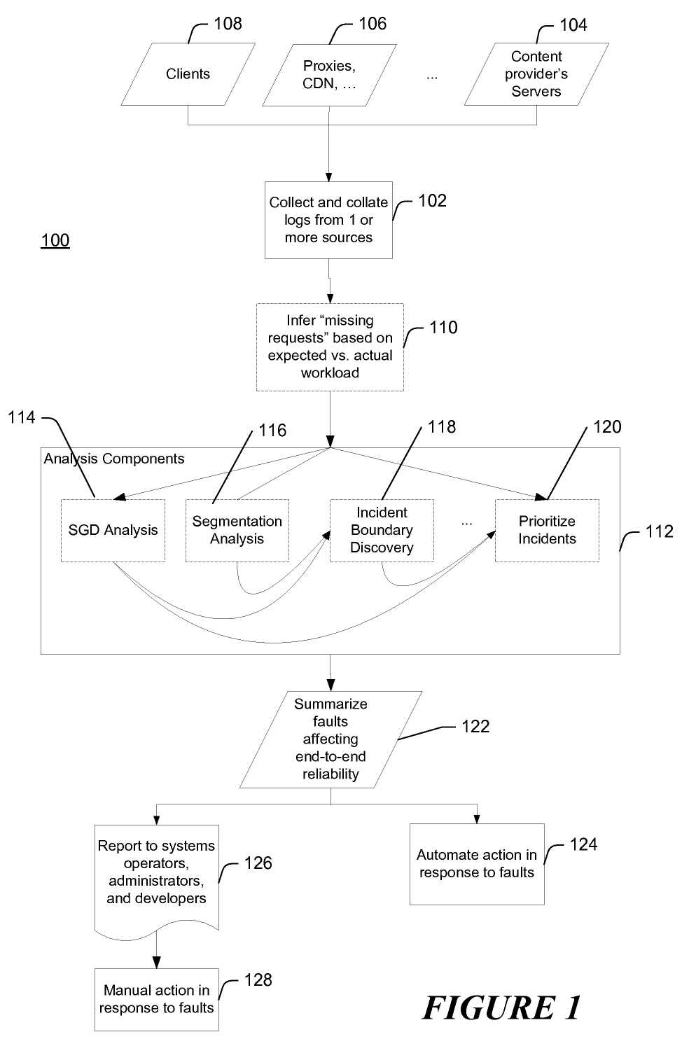

These techniques help resolve reliability problems in the wide-area network that affect end-user perceived reliability by focusing troubleshooting efforts, triggering automatic responses to failures, and alerting operators of the failures so that corrective actions may be taken. Various examples of mining web logs to debug distant connectivity problems are described below with reference to FIGS. 1-5.

### Example System Architecture

Referring to FIG. 1, there is shown a workflow 100 of a computer based process for analyzing web logs to debug wide-area network failures. The first stage 112 of workflow 100 is to collect and collate web logs (records of a request for messages, such as HTTP requests, success or failure and a time of the success/failure) from one or more locations across the Internet. The source of the web logs that might be recorded may include, for example, the service provider's central servers 104, servers 106 such as proxies or content distribution network nodes (CDNs) distributed across the wide-area network, or client's web browsers 106 (if clients have agreed to share their experience with the service provider). If the web logs are being collected from more than one source, then the web logs should be sorted by the timestamp of when requests occurred, and multiple records of the same requests' success/failure should be merged.

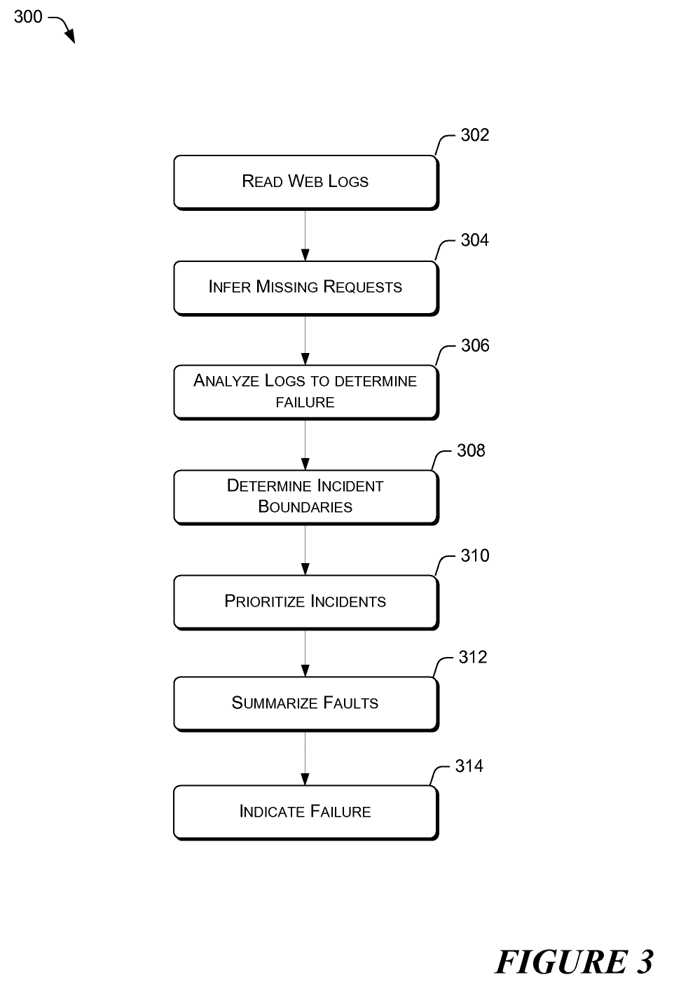

In stage 110, the process may infer “missing information.” Inferring missing information may require the process of determining the set of requests that might not be reaching a logging location. The details of this inferral process are discussed in the context of FIG. 3. This stage 110 of the overall process is optional, depending on how complete the collected logs are, and whether there are many failed requests not being recorded in the collected logs.

Stage 112 consists of specific analysis techniques (114-120) for detecting, localizing, prioritizing and otherwise debugging failures in the wide-area network infrastructure, web clients, and service provider's service. These analyses may receive as an input 1) the collected web logs; 2) the output of the missing request inferral process; and 3) the output from one or more other analyses in the analysis stage.

One of the analyses techniques in stage 112 is the stochastic gradient descent (SGD) analysis technique 114 for attributing failed requests to potential causes of failures, including network failures, broken client-side software, or server-side failures.

Another analysis in this stage 112 is the segmentation analysis technique 116, for detecting the beginning and/or end of an incident that affects the system-wide failure rate. One embodiment of the segmentation analysis technique 116 is an application of an existing time-series segmentation technique to a new domain. The analysis technique 116 and alternate embodiments are described in more detail herein.

Analysis technique 118 combines the results of the SGD analysis 114 and segmentation analysis 116 to characterize when major incidents affecting the system-wide failure rate began, which components in the network infrastructure (referred to herein as “infrastructure components”) are most correlated with the failure, and when the incident ended.

Other analysis techniques that fit in stage 112 include techniques to recognize classes of failures (e.g., DNS failures, network link failures, router mis-configurations), techniques for recognizing recurring failures (e.g., repeated problems at the same network provider); techniques for discovering incident boundaries (technique 118) and techniques for prioritizing of incidents (prioritize incidents technique 120) based on their overall impact, duration, recurrence, and ease of repair.

The output of the analysis stage 112 is fed to stage 122 that provides a summary of the failures that are affecting end-to-end client-perceived reliability, including failures in the wide-area network infrastructure, client software, and server-side infrastructure. This summary output may trigger an automated response in stage 124 to some failures (e.g., minor reconfigurations of network routing paths or reconfigurations or reboots of proxies or other network infrastructure).

The output of the stage 122 can also be used to generate a human-readable report of failures in stage 126. This report can be read by systems operators, developers and others. Based on this report, these users may take manual action in stage 128 to resolve problems. For example, they may make a phone call to a troubled network provider to help the provider resolve a problem more quickly.

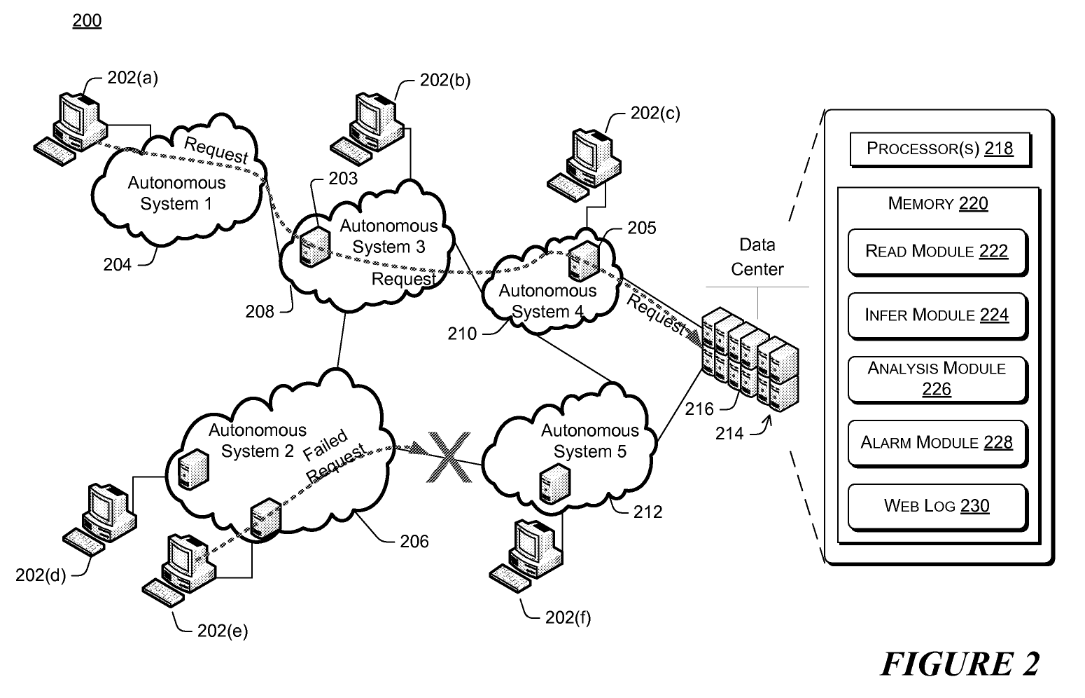

FIG. 2 illustrates an example system 200 in which data mining and analysis of web logs may be implemented to detect and resolve wide-area connectivity problems in third-party networks. The system includes clients connected via several cooperating networks and other elements of infrastructure, collectively referred to as components. As illustrated in the figure, example components include DNS servers, servers in a content distribution network (CDN), and networks. In this figure, networks are defined by their Autonomous System (AS) number assignments. In other cases, the unit of definition for a network may be made at a finer or coarser granularities (for example, by IP address subnet, prefix, BGP atom, or geographic region). Logs or records relevant to an exchange of messages between the client and service provider may be available from any of the components involved in processing a message or any ancillary or prerequisite components used by those components. Any component creating such logs provides a potential vantage point on the exchange of messages.

The system includes multiple client devices 202(a-f) that can communicate with one another via a number of cooperating administrative domains or sub-networks, referred to herein as autonomous systems (ASes) 204-212. In one embodiment, units (such as client devices) belonging to one network that is separate from another network, have unique Autonomous System (AS) assignments. In other cases, definition for one network may be made at finer or coarser granularities. The client devices 202(a-f) can also communicate via one or more ASes 204-212 to a data center 214, which may include one or more content servers 216 of the service provider.

The example system 200 generally allows requests for web content to flow from a user's web browser on one of client devices 202(a-f) through one or more content servers 216 of a service provider, such as those located at data center 214, and then back to the user's web browser. Data center 214 may host content to provide an Internet service to users of client devices 202(a-f). Typically, at the transportation and application layer in a system 200, requests originate on one of client devices 202(a-f) as the client uses the network infrastructure, such as a domain name server (DNS), to resolve the name of the requested desired website. The DNS response may specify a server owned by the service provider, or that of an infrastructure provider (e.g., Akamai, Inc. of Cambridge, Mass.). When one of the client devices 202(a-f) opens a transmission control protocol (TCP) connection to transmit its request for content, the connection may be directed through a proxy 203, to an infrastructure server 205, or directly to the service provider at data center 214. If an infrastructure provider or proxy is involved, they may internally route the request through several hops and/or DNS lookups. For each of these steps, packets may need to flow across and between multiple ASes, such as Ases 204-212.

The one or more content servers 216 in the data center 214 may contain system components configured to collect, store and mine web logs that may be subsequently used to detect, debug and resolve any connectivity problems between the client devices 202(a-f) and the service provider's data center 214.

For example, as shown in FIG. 2, a request originating from client device 202(a) successfully reached the one or more content servers 216 in the data center 214 via AS1 204, AS3 208 and AS4 210. However, a request originating from client device 202(e) failed to reach the one or more content servers 216 in the data center 214 because the request failed when AS2 206 attempted to send a request to data center 214 via AS5 212 due to connectivity problems.

Generally speaking, there may be many factors that can contribute to connectivity problems between one of client devices 202(a-f) and the data center 214. These possible sources may include routing policy, network congestion, failure of routers, failure of network links inside and between each AS, and failure of infrastructure servers, such as Akamai® proxies or other content-distribution network (CDN). Any of these factors may cause one of client device 202(a-f) to lose connectivity to the data center 214 or experience decreased service quality, such as delayed responses, incorrect responses, or error responses.

In order to debug connectivity or service quality problems, the data center 214 may be equipped with process capabilities and memory—in excess of the required capacity solely as a service provider—suitable to store and execute computer-executable instructions. In this example, the data center 214 includes one or more processors 218 and memory 220. The memory 220 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computer system.

Stored in memory 220 are a read module 222, an infer module 224, an analysis module 226, and an alarm module 228. The modules may be implemented as software or computer-executable instructions that are executed by the one or more processors 218. Web logs 230 may also reside in memory 220.

Web logs 230 may be transaction logs collected when client devices 202(a-f) via a plurality of ASes 204-212 access one or more content servers 216 in the data center 214. Web logs 230 may contain records of all HTTP requests, as well as a record of whether the HTTP requests were successful or not. Web logs 230 may also include client-side logs from a subset of customers operating client devices 202(a-f), (such as paid or volunteer beta-testers, 3^{rd} party that measure site reliability, etc), who have agreed to log and report their view of the service. Web logs 230 may also includes content delivery network (CDN) record logs. CDN record logs record the success and failure of every request that passes through CDN proxies, even if the wide-area network failures prevent these requests from reaching the Internet service itself. Web logs 230 may also include central logs that contain records of every request that reached the content servers 216 at data center 214.

The read module 222 may be used by the data center 214 to read a plurality of web logs 230 of requests that are collected when a plurality of devices 202(a-f) via ASes 204-212 access one or more content servers 216. Infer module 224 may be configured to infer the existence of request failures that have not reached a logging source. For example, if web logs 230 are only collected from a service provider's data center, web logs 230 may only contain records of requests that were able to reach the data center. Any request that failed to reach the data center (e.g., because of a wide-area network failure) would not be represented in the web logs 230. To infer the existence of such missing (failed) requests, the infer module 224 may be configured to first estimate the workload that one or more content servers in data center 214 is expected to receive from a candidate (e.g., a specific one of client devices 202(a-f), AS 204, or other devices in other subdivisions of the Internet). In one embodiment, the infer module 224 may determine this estimate based on knowledge of (1) the past request workload the one or more content servers 216 in data center 214 received from the candidate, including the time-varying workload pattern of the content servers 216; and (2) the current request workload the one or more content servers 216 in data center 214 are receiving from the candidate's peers. The peers of a given candidate are those whose workloads are historically correlated to the candidate.

For example, if the one or more content servers 216 in data center 214 are expected to receive request workload from a financial company, by analyzing the workload patterns across many ASes, such as ASes 204-212, it may be determined that financial trading companies in a particular city, such as New York City, provided request workloads that correlate with each other. In such a case, the infer module 224 may be configured to predict an expected request workload from any one of these companies, based on the request workloads being received concurrently from the other New York City financial trading companies. Additional exemplary analysis is described in co-pending application entitled “Method to identify anomalies in high-variance time series data” filed concurrently with this application which is hereby incorporated by reference.

Once the request workload has been estimated by the infer module 224, the infer module 224 may pass this estimate to the analysis module 226. The analysis module 226 may be configured to compare the estimated request workload to request workloads actually observed in the web logs 230 (as obtained by the read module 222) to determine the failure rate. For example, if the analysis module 226 determines that the number of expected requests is higher than the number of requests that are observed in the web logs 230; the analysis module 226 may determine that some type of failure is preventing requests from reaching the data center 214 and being recorded in the web logs 230. The use of past workload information and current workload information from the candidate's peers may provide accurate estimates of request failures due to technical difficulties, while advantageously avoiding false alarms (e.g., drops in workload that results from social causes such as holidays).

Moreover, in one embodiment, the analysis module 226 may be configured to estimate a failure probability for each component of the system infrastructure (including the client's browser and the service provider's servers). When a serious problem occurs, the probable failure rate of some component of the infrastructure (also referred to herein as a “candidate”) generally increases. Accordingly, the detection of the likely malfunction of a particular component of the infrastructure based on its probable failure may enable an Internet service provider to take remedial measures, such as contacting the owner of that component and encouraging the owner to repair the faulty component.

In order to find a root cause of the failure from the record of the HTTP requests, the analysis module 226 may comprise a noisy-OR model routine. In performing the noisy-OR model routine, a stochastic gradient descent (SGD) analysis may be applied to overall failure/success rates of the HTTP requests, as obtained from the web logs 230, to create on-line estimates of the underlying probability that each candidate is the cause of the observed failures. The process for the application of SGD analysis to perform a noisy-OR model is described below.

In one embodiment, the analysis module 226 determines candidates that may cause the HTTP request to fail. This is equivalent to determining the set of candidates which were involved in the initiation, transport or servicing of the request. As an example, three types of candidates that may be considered are (1) the specific Internet site or server being contacted (i.e., the site's hostname); (2) the network in which the client resides; and (3) the client's browser type. However, in an alternative embodiment, transit networks between the content servers and the clients may also be considered as candidates. Regardless of the particular embodiment, for the purpose of applying an SGD, the candidates associated with each request i may be labeled as Cᵢ.

The analysis module 226 calculates the probability Pᵢ that any given request i is going to fail. This probability is computed in equation (1) as a noisy-OR of the probabilities qⱼ that any of the candidates j ε Cᵢ associated with the request fails:

$${P}_{i} = 1 - {\prod }_{j ∈ ci}^{ } ( 1 - {q}_{j} ) \qquad ( 1 )$$

qⱼ is then parameterized to be a standard logistic function of the of the log odd zⱼ in equation (2):

$${q}_{j} = \frac{1}{1 + {e}_{j}^{- z}} \qquad ( 2 )$$

For every new request, the estimates of the failure probabilities of the candidates associated with the request are updated. These updates are in the direction of the gradient of the log of the binomial likelihood of generating the observations given the failure of probabilities:

$$\begin{matrix}D = {y}_{i} log ( {p}_{i} ) + ( 1 - {y}_{i} ) log ( 1 - {p}_{i} ) & ( 3 ) \\ Δ {z}_{j} = η \frac{\partial D}{\partial {z}_{j}} = η \frac{qj ( {y}_{i} - {p}_{i} )}{{p}_{i}} & ( 4 )\end{matrix}$$

Where η is a weight that controls the impact of each update, and γᵢε{0,1} indicates the observed success (γᵢ=0) or failure (γᵢ=1) of an HTTP request i.

In one embodiment, an exemplary initial value of zⱼ=−5 is used for all candidates j. For each request i, updates are applied only to the candidates j involved in that request. Since not all candidates are involved with each request are processed, the posterior probabilities of each candidate j diverge from each other.

Empirically, it has been found that using a relatively high value of η=0.1 and applying an exponential smoothing function on the gradient, Δzⱼ, provides a good trade-off between responsiveness to failures and stability in reported values. Thus, a smoothed gradient, \tilde{Δ}zⱼ, at time t, may be calculated as:

\tilde{Δ}zⱼ^{t-1}+(1−α)Δzⱼ^{t} (5)

Accordingly, the analysis module 226 may be configured to interpret the resultant probabilities qⱼ as follows. An estimated failure probability approaching 100% implies that all the requests dependent on the candidate j are failing, while a probability approach 0% implies that no requests are failing due to candidate j. An estimated probability of failure that is stable at some value between 0% and 100% may indicate that the candidate j is experiencing a partial failure, where some dependent requests are failing while others are not. For example, an AS that drops half of its outgoing connections may have a failure probability estimate approaching 50%.

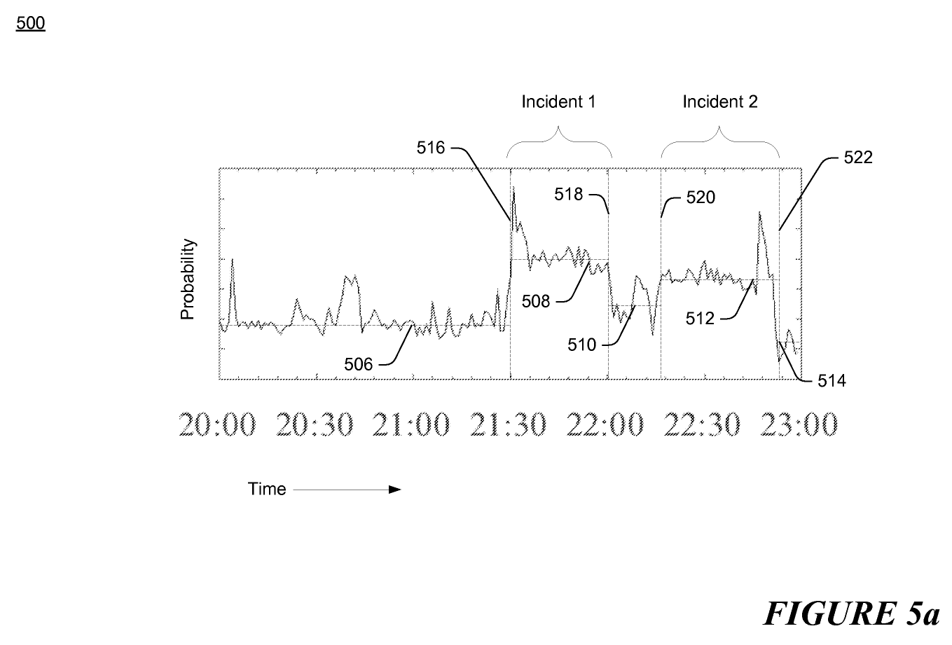

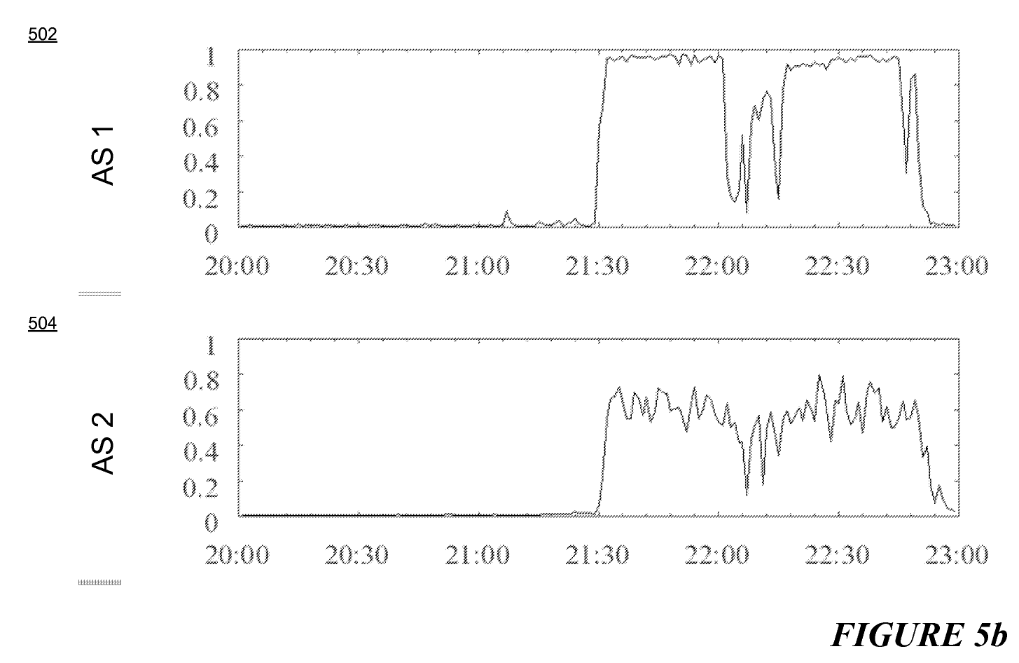

Moreover, in another embodiment, the analysis module 226 may be further configured to collect related failures into incidents. The collection of related failures may enable the recognition of recurring problems. In one embodiment, the collection of related failures into incidents may be accomplished by segmenting a time-series of a failure rates into regions (See FIGS. 5A AND 5B), where the time series values within each region are generally similar to each other, and generally different from the time-series values in neighboring regions. This is equivalent to finding the change points in a time series. In this model, a transition boundary between two regions represents abrupt changes in the mean failure rate, and thus, the potential beginning or end of one or more incidents.

In such an embodiment, given a time-series of failure rates x₁, . . . xₙ, the analysis module 226 may be configured to mathematically find a segmentation of the time series into k regions, so that the total distortion (D) is minimized:

D=Σₘ₌₁^{k}Σᵢ₌₈_{_{m−1}}⁸^{ₘ}+1^{(Xi-μm)}^{²} (6)

where sₘ represents the time-series index of the boundary between the m^{th} region and the (m+1)^{th} region, s₀=0, sₖ=n, and

$${μ}_{m} = \frac{{\sum }_{t - {l}_{m - 1}}^{{l}_{m}} + {1}^{{x}_{1}}}{{8}_{m} - {8}_{m} + 1} ,$$

wherein μ is the mean value of time series throughout the m^{th} region. The analysis module 226 then implements a dynamic programming algorithm to find the set s of boundaries that minimize D.

To fit the parameter k, the analysis module 226 may use one of the many model fitting techniques generally known in the statistical pattern recognition and statistical learning field. In one embodiment, the analysis module 226 may first generate a curve of distortion rates by iterating over k. Then the analysis module 226 may select the value of k associated with the knee in the distortion curve. Selecting the value k to be associated with the knee balances the desire to fit the boundaries to the data while avoiding the problem of over-fitting (since overall distortion approaches 0 as k approaches n and every time period becomes its own region). Nevertheless, it is important to note that segments found by the analysis module 226 using the above algorithm corresponds to the beginning or end of one or more incidents, rather than either an incident or incident-free period.

In an alternate embodiment, the method taught in U.S. patent application Ser. No. 11/565,538, entitled “Grouping Failures To Infer Common Causes”, and filed on Nov. 30, 2006 may be used to identify incident boundaries by using the method to group failure indications. In this embodiment, any SGD value above a threshold or any component that appears to have missing messages is used as a failure indication input to the taught method. The taught method then outputs a grouping of the failure indications. An incident is said to start whenever a failure group becomes active and to stop when the failure group is no longer active.

Finally, the alarm module 228 may be employed to automatically indicate a failure of a particular network, e.g., an AS, when the failure rate of the network exceeds a predetermined threshold value or abruptly changes. This change may be detected at the segment boundaries. This predetermined threshold may be set by observing failure rates of system components over time and setting the threshold value as a percentage of the observed average failure rate e.g. 120% of the average failure rate.

In another example, the alarm module 228 may be set to indicate a failure when the failure rate of a particular network or group of networks changes by increasing by a certain proportion, such as when the failure rate doubles or triples at the segment boundary.

Likewise, in an alternative embodiment, alarm module 228 may be employed to automatically indicate the system-wide failure of a network that includes a plurality of network components, e.g., many ASes. For example, this indication may occur when the system-wide failure rate exceeds the predetermined threshold.

In other embodiments, the alarm module 228 may be employed to automatically indicate a failure of a particular network component, e.g., an AS, when the failure probability of the component, as estimated by the SGD analysis, exceeds the predetermined threshold. For example, the alarm module 228 may indicate a failure of an AS when the AS failure probability exceeds 50%.

In additional embodiments, the alarm module 228 may transmit an electronic message, generate a report, or activate visual and/or aural signals to alert an operator who is monitoring the particular network component.

### Exemplary Process

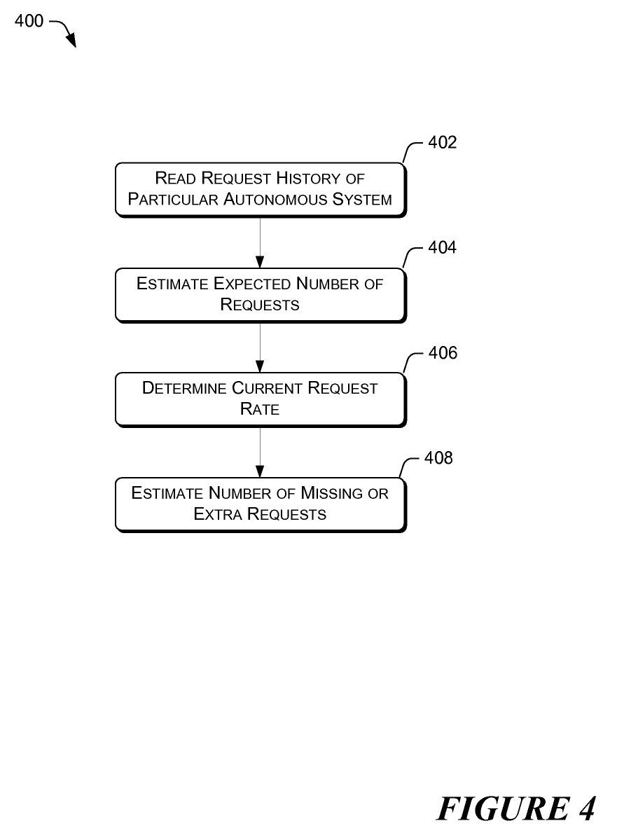

The exemplary processes in FIG. 3 and FIG. 4 are illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to system 200 of FIG. 2, although it may be implemented in other system architectures.

FIG. 3 illustrates a flow diagram of an exemplary process 300 for mining web logs to debug distant connectivity problems with the architecture shown in FIG. 2. In one embodiment, process 300 may be executed using a server 216 within data center 214. At block 302, the read module 222 reads web logs 230 and stores the logs in memory 220 so that they may be processed by infer module 224 and analysis module 226. The read module 222 may be activated in response to commands from an operator or server 216 or may be periodically or automatically activated when the infer module 224 or the analysis module 226 needs information. The web logs 230 may include, for example, client-side logs, CDN logs, and/or central logs.

At block 304, the infer module 224 infers missing requests, that is, the existence of request failures that have not reached a logging source. Further details of the process for inferring missing requests are described in FIG. 4.

At block 306, the analysis module 226 analyzes the web logs to determine system component failure probabilities, that is, the estimate of the failure probability of each component of the system infrastructure (including the client's browser and the service provider's servers) based on the failed requests. This may be accomplished by first determining the set of candidates which generated the requests (e.g., clients, autonomous systems, or other subdivision of the Internet) and then applying SGD analysis to the failure/success rates of the requests.

At block 308, the analysis module 226 determines failure incident boundaries (See FIGS. 5A and 5B) by segmenting a time series of the failure rates into segments, and identifying change points (“incident boundaries”) in the time series of failure rates. This determination of incident boundaries may be accomplished by using an algorithm for detecting one or more abrupt changes in the failure rate. At block 310, the analysis module 226 prioritizes the incidents based on some measure of the significance of the failure rate, such the number of users affected by the failure, the revenue produced by the users affected by the failure, the frequency of recurrence of the failure, or some other metric as determined by the service provider and its business requirements. The incidents may be marked with a time stamp and may be stored in memory sorted by their priority.

At block 312, the failure incidents supplied by the analysis module 226 is summarized. This summary may outline failures that are affecting end-to-end client-perceived reliability. These failures may include, for example, failures in the ASes, wide-area network infrastructure, client software, and server-side infrastructure. The supplied incidents may trigger an automated response to some failures (e.g., minor reconfigurations of network routing paths, reconfiguration or reboot of proxies, or reconfigurations of other network infrastructure). At block 314, the summary of the failure are indicated using alarm module 228. The failures may be indicated by generating human-readable reports of failures. The reports can be read by system operators, developers and others. Based on these reports, responsible personnel may take further action to resolve the problems. For example, operators may make phone calls to troubled networks to assist the providers to resolve particular problems more quickly.

FIG. 4 illustrates a flow diagram of an exemplary process 400 for inferring missing requests to determine failures. Process 400 further illustrates block 304 of exemplary process 300, as shown in FIG. 3. At block 402, the read module 222 reads the request history of particular ASes 204-212 from web logs 230. At block 404, the infer module 224 estimates the expected number of requests. This estimate may be based on the past workload of one or more ASes, or the current workload of comparable ASes. At block 406, the analysis module 226 uses the request history and the estimated number of requests to determine a current request rate. Such rates may be determined by correlating a request history with comparable workloads. At block 408, the analysis module 226 estimates the number requests that are missing from the request history or are extra in the request history by taking a difference between the number of requests in the request history and the number of estimated requests. Once the numbers of missing or extra requests have been determined, the process returns to block 306 of the exemplary process 300 for analysis to determine failure.

### Exemplary Observed Failure Rate

FIGS. 5a and 5b illustrates graphical representations of an observed system-wide failure during a 3-hour period. FIG. 5a illustrates the overall failure rate 500 during this 3-hour period, and FIG. 5b illustrates failure probability of individual ASes during the period. As shown, FIG. 5a indicates an initial low rate of background failures beginning from 20:00. The background failures may be due to broken browsers and problems at small ASes. However, at 21:30, one or more abrupt failures occurred that increased the failure rate for approximately 85 minutes. FIG. 5a further illustrates the result of the algorithm, as described above, which segments a time series of failures rates into segments based on change points. As indicated by FIG. 5a, the application of the algorithm segmented the system-wide failure rate into five regions. The five segments are denoted by knees 506-514, and boundaries 516-522. Each segment boundary corresponds to the beginning or end of one or more incidents. For example, boundaries 516 and 518 may indicate the beginning and end of incident 1. Likewise, boundaries 520 and 522 may indicate the beginning and end of incident 2.

FIG. 5b illustrates the failure probability 502 and 504, of exemplary AS1 204 and AS2 206, respectively, as estimated using SGD analysis. The failure of AS1 204 and AS2 206 contributed to the overall system-wide failure rate shown in FIG. 5a. As shown in FIG. 5b, failures 502 and 504, as indicated by the failure probabilities estimated using SGD analysis, account for almost all the error-load that occurred during the 3-hour period (rising 95% within 2-3 minutes of the beginning of the incident). FIGS. 5a and 5b illustrate that SGD analysis, in correlation with success/failure rates of HTTP requests, may enable the recognition of problems. For example, if AS1 204 and AS2 206 are located in the same geographical region, failure rate 502 and 504 may lead to a conclusion that AS1 and AS2 share some relationship in the network topology, and a single failure caused both ASes to be unable to reach a service provider, such as data center 214.

### Conclusion

In closing, although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. An analysis system comprising:
one or more computers to infer an impact of one or more infrastructure component(s) on service quality experienced by clients of a service provider based on an analysis of records of messages sent between the clients and the service provider, said records of messages either explicitly or implicitly representing effects of a plurality of the infrastructure components on the message's achieved quality of service, and wherein at least some of the infrastructure components are external to an administrative domain of the service provider.

2. The system of claim 1, wherein the one or more computers further comprise means for distinguishing between problems in components internal to the service provider's administrative domain and components external to the service provider's administrative domain.

3. The system of claim 1, wherein all the infrastructure components are external to the administrative domain of the service provider.

4. The system of claim 1, wherein the records of messages are gathered from one or more vantage points.

5. The system of claim 1, wherein the records are records of one or more message types, wherein the message types are selected from a group comprising: hyper text transport protocol (HTTP) requests and responses, instant messenger connections, instant messenger messages, instant messenger interactions, video streaming messages, and remote procedure calls.

6. The system of claim 1, wherein the one or more computers infer properties of an impact of one or more infrastructure components, wherein the properties include one or more properties from a group comprising: a positive or negative impact of the component on the service quality experienced by the clients over time, a frequency, duration, and recurrence of negative and positive impacts, and the significance of the impact in comparison to other impacts according to a predetermined metric.

7. The system of claim 1 wherein the computer identifies boundaries of time periods of anomalous service quality.

8. A method comprising:
analyzing records of messages sent between a service provider and its clients' via a network comprising one or more components, wherein each record represents a result of the components' effect on a message's status or a quality of service gathered from one or more vantage points; and
determining from the analyzing one or more determinations from a group of determinations comprising:
whether a problem is occurring internal or external to an administrative domain of the service provider,
which of the one or more components external to the service provider's administrative domain are healthy or not healthy, or
an impact of the healthy and unhealthy components on the quality of service experienced by clients.

9. The method of claim 8 wherein the service provider includes infrastructure components; and wherein all the infrastructure components are external to an administrative domain of the service provider.

10. The method of claim 8 wherein the records are records of one or more types of messages, wherein the types of messages are selected from a group comprising: hyper text transport protocol (HTTP) requests and responses, instant messenger connections, instant messenger messages, instant messenger interactions, video streaming messages, and remote procedure calls.

11. A computer readable medium comprising computer-executable instructions that, when executed by one or more processors, perform acts comprising:
reading a plurality of records of messages sent between a service provider and its clients through a network or set of cooperating networks, including a set of infrastructure components; and
determining from original or preprocessed records of messages using analysis, effects of the networks or the infrastructure components on a quality of service achieved by the original messages.

12. The computer readable medium as recited in claim 11 further comprising preprocessing the plurality of records of messages to create a set of preprocessed records of messages.

13. The computer readable medium as recited in claim 11 wherein the one or more acts are executed in sequence or in parallel.

14. The computer readable medium as recited in claim 12 wherein one or more of the set of preprocessing acts comprises inferring missing records of messages between a service provider and its client that did not reach a vantage point.

15. The computer readable medium as recited in claim 11 wherein determining the effects includes a determination of a group comprising:
an occurrence of user-affecting incidents at one or more of the plurality of networks and infrastructure components;
when user-affecting incidents at one or more of the plurality of networks and infrastructure components have begun or ended;
a failure rate of one or more of the plurality of networks and infrastructure components;
a prioritization of the effects of one or more of the plurality of networks and infrastructure components or the user-effecting incidents occurring therein; and
a relationship between the effects of two or more of the plurality of networks and infrastructure components or the user-effecting incidents occurring therein.

16. A server comprising:
a read module to read a plurality of records of messages transferred between a service provider and its clients through a network or set of cooperating networks, including a set of infrastructure components;
an analysis module to determine from said records user-affecting incidents occurring at one or more of the plurality of networks and infrastructure components, and properties of said incidents; and
an alarm module to indicate one or more determined user-affecting incidents of the networks and infrastructure components.

17. The server as recited in claim 16 further comprising an infer module to infer missing records of messages records of messages between the service provider and its client that did not reach a vantage point.

18. The server as recited in claim 16, wherein the records of messages comprise a listing of hyper text transfer protocol (HTTP) requests to the service provider from a plurality of client electronic devices, and wherein the records of messages indicate whether or not such request was successful.

19. The server as recited in claim 16, wherein the analysis module determines a beginning or end of a user-affecting incident occurring in one or more of the plurality of networks and the infrastructure components, and wherein the alarm module generates an automated alarm in response to the occurrence of the incident.

20. The server as recited in claim 16, wherein the alarm module transmits indications selected from one or more of a group of indications comprising: an electronic message, generate a report, or activate visual and/or aural signals to alert an operator of a network or infrastructure component at which a user-effecting incident is occurring.
